(19) United States
(12) Patent Application Publication
(10) Pub. No.: US 2004/0238322 A1
(43) Pub. Date: Dec. 2, 2004

(54) DEVICE FOR REMOVAL OF CONTROLLER ASSEMBLY FROM ESCALATOR PIT

(76) Inventor: Barry Jay Viola, Arkansas City, KS (US)

Correspondence Address: Barry Jay Viola, 33662 51st Road, Arkansas City, KS, 67005, US

(21) Appl. No.: 10/445,158

(22) Filed: May 27, 2003

(51) Int. Cl. B65G 17/00

(52) U.S. Cl. 198/321

(57) ABSTRACT

In accordance with the present invention, there is a need for removal of the controller assembly from its stored location within the escalator pit for the purpose of working on the escalator or the escalator controller itself. The risk for human injury associated with this removal can be eliminated through the use of the present invention, that of a power driven ejection device for the automatic removal of the escalator controller from the escalator pit, with the main components of the automatic ejection device being the mounting base/guide tube, the drive system, the carriage, the main attachment pin and the controller attachment bracket, the automatic pivoter and the optional latch and manual release.

### CROSS REFERENCE TO RELATED APPLICATIONS

None

### FEDERALLY SPONSORED RESEARCH

There is no Federally sponsored research associated with this application.

### REFERENCE TO SEQUENCE LISTING

None

### FIELD OF THE INVENTION

The present invention relates to escalator controller assemblies and, more particularly, to the removal of the controller assembly from the escalator pit.

### BACKGROUND OF THE INVENTION

Escalators, also known as moving stairs, and when horizontal moving walks, are a useful aid in moving people from one elevation to another. An escalator is composed of two endless chains to which steps are attached. These chains travel from the lowest elevation of the escalator up to the highest elevation, around a set of sprockets, back to the bottom and around another set of sprockets where they endlessly repeat the journey. It is these chains to which the steps attach, linked one after another that provide for the moving stairs that people ride. In order to contain, support and conceal the mechanisms and apparatus of an escalator, a structural truss is provided. This truss is the main skeleton of the escalator and is concealed beneath the portion that is ridden. At each end of the truss is a pit, with there being two pits, an upper and a lower. The upper pit, located at the upper elevation, contains the escalator driving system along with the controller assembly, which is composed of a multitude of electrical components such as relays and transformers, all contained in an enclosure, with the total weight of this controller assembly being in excess of what is safe for a human to lift without the chance of injury.

This upper pit is contained underneath the portion of the escalator called the floor plate. The floor plate is the stationary floor area at each egress of the escalator. These floor plates are removable to provide access to the pit below. Because of space constrictions it is required to remove the controller assembly from the escalator pit to perform work on it, and as such, controller assemblies are constructed with flexible cables to allow their removal from the pit. This removal process is done manually by the service technician performing work on the escalator. Because the controller assembly is located beneath the technician, the technician is forced to bend over putting them and their back in a weakened position. This combined with the weight of the controller assembly poses a dangerous situation that can easily result in injury. There are no solutions in existence. Manufacturers have provided handles on top of the controller assembly enclosure as an aid in gripping the controller assembly for manual removal, but no actual device to replace human effort has been provided.

It is therefore an object of this invention to provide a means for removal of an escalator controller assembly from an escalator pit that will eliminate the need for manual removal, thereby eliminating the potential for human injury.

It is another object of this invention to provide a means for removal of an escalator controller assembly from an escalator pit, thereby eliminating the possibility of damage to the escalator components such as flexible control cables, drives and other components that may be damaged by human entry into the pit for the purpose of controller assembly removal.

It is another object of this invention to provide a means for removal of an escalator controller assembly from an escalator pit, eliminating the chance for human injury that may happen from entering into the pit for the purpose of controller assembly removal. It is another object of this invention to provide a means for removal of an escalator controller assembly from an escalator pit, thereby eliminating the need for human contact with the controller assembly and the chance for damage to the controller assembly possibly caused by dropping or hitting the controller while removing it.

It is another object of this invention to provide a means for removal of an escalator controller assembly from an escalator pit, thereby eliminating the need for human contact with the controller assembly and the potential for human injury that could be incurred due to dropping the controller on an appendage.

It is another object of this invention to provide a means for removal of an escalator controller assembly from an escalator pit, thereby providing a physical means to attach the flexible control cables to, to prevent their snagging and dislodging from the controller during removal.

### BRIEF SUMMARY OF THE INVENTION

In accordance with the present invention, there is a need for removal of the controller assembly from its stored location within the escalator pit for the purpose of working on the escalator or controller assembly itself. Due to the tight space restrictions within the escalator pit it is necessary to remove the controller assembly prior to working on the escalator or controller assembly. As such, controller assemblies for escalators are designed to be removed from the pit and placed upon the floor where access can then be gained to the pit, or the controller assembly itself.

Escalator controller assemblies are of sufficient weight as to cause human injury when attempting to remove them from the pit. This weight combined with their stored location being below floor level pose an unnecessary risk for injury, which can be eliminated with the use of the present invention, that of a power driven ejection device for the automatic removal of an escalator controller assembly from the escalator pit.

The main components of this ejection device are the drive, the base/guide, the carriage, the attachment linkage, the optional automatic pivoter and the optional latch with manual release.

The drive shown is that of an electric gear motor driving a shaft, upon which, chain type driving sprockets are mounted. These driving sprockets convert the rotary motion of the gear motor into the linear motion of the drive chains. The drive chains travel approximately the height of the pit where they travel around sprockets and return, with the ends of the drive chains attached to the ejector carriage. In this way the carriage travels vertically upward to eject the controller assembly and vertically downward to replace the controller assembly. The drive shown, that of an electric gear motor, is intended as a sample representation only. Any means of power assistance such as hydraulics, pneumatics, screw drives, or other means of stored energy such as springs or counterweights, means of mechanical advantage such as linkages and levers, or other devices to provide aid and assistance in the ejection of the controller assembly may be used.

The base/guide provides the central mounting points for the components of the automatic ejector. The base is attached to the escalator truss as a means of support. The base provides mounting for the drive system as well as providing a guide for the carriage to travel on as it moves up and down. The base/guide shown is a typical representation and is not intended to be limiting to one form alone. Other guides such as cables, threaded rod or other means may be used.

The carriage is contained around the guide tube and is free to move up and down as driven by the drive chains. As the drive motor receives its signal, the drive shaft and sprockets rotate causing the chains and carriage to travel in the desired direction. Through a rotating attachment pin the carriage is attached to the controller assembly, thereby providing for the point of interface between the automatic ejector and the controller assembly. This attachment pin allows the carriage to raise or lower the controller assembly along with it thereby either raising and ejecting the controller assembly from the pit or lowering and replacing the controller assembly back down into the pit. The carriage shown is pictorial in nature only and is intended only to depict the means of translating motion from that of the drive into a into a useable means to eject the controller assembly from the pit and replace it.

The attachment linkage is a quick release pin that ultimately connects the carriage to the controller assembly enclosure. This pin lifts and holds the controller assembly as it travels yet allows the controller assembly to rotate about the pin. In this manner the carriage is able to lift the controller assembly vertically, thereby ejecting it from the escalator pit, yet still allow the controller assembly to pivot from vertical to horizontal so that service may be performed upon it. With the pin being quick release, the controller assembly can easily be disconnected from the carriage assembly for manual removal of the controller assembly in the event of automatic ejector malfunction or loss of power. The linkage pin is representative of a quick release attachment system that allows the carriage to easily connect and disconnect from the controller assembly. It is not intended to be the only method of attachment.

The optional automatic pivoter is a linkage that is activated according to the location of the carriage and controller assembly as they travel up and down the guide tube. As the controller assembly approaches the upper end of travel the automatic pivoter arms rotate upward engaging the controller assembly and automatically rotate the controller assembly from vertical to horizontal. Likewise, as the carriage travels downward the automatic pivoter arms are free to retract and are forced to do so by the weight of the controller assembly, thereby allowing the controller assembly to return to the vertical position. The automatic pivoting means shown in the present invention is intended as a sample and is not intended to be restricted to that form only. Other forms of automatic pivot can be used such as cam operated, electric operated or other operation.

The optional latch with manual release is available in place of the automatic pivoter to retain the controller assembly in a vertical position until the service technician is ready to manually release it from the vertical position and allow it to rotate to horizontal after ejection, with his assistance. This option is especially useful in tight space configurations where automatic pivot may not be practical to use. The latch with manual release shown is typical and is not intended to be restrictive in nature as to the type of latch and release used.

An additional configuration for operation of the automatic ejector is to have the controller assembly rotated 180 degrees from its conventional orientation. Conventional orientation of an escalator controller assembly is its back to the wall of the pit and the front, where the door is, facing the interior of the pit. In this new reversed mode upon being vertically ejected the controller assembly is now facing the service technician who can then simply open the door.

### BRIEF DESCRIPTION OF THE DRAWINGS

A complete understanding of the present invention may be obtained by reference to the accompanying drawings, when considered in conjunction with the subsequent, detailed description, in which;

FIG. 1 is a side view of the upper portion of an escalator.

FIG. 2 is a side view of the upper portion of an escalator showing conventional means (manually) for removal of the controller assembly from the upper pit;

FIG. 3 is a side view of the upper portion of an escalator showing the automatic ejector mounted in the upper pit.

FIG. 4 is a side view of the upper portion of an escalator showing the controller assembly partially removed from the pit through the use of the automatic ejector;

FIG. 5 is a side view of the upper portion of an escalator showing the controller assembly fully removed from the pit through the use of the automatic ejector;

FIG. 6 is an exploded perspective view of the automatic ejector showing the individual components;

FIG. 7 is a perspective of the automatic ejector with the carriage lowered;

FIG. 8 is a perspective of the automatic ejector with the carriage raised;

FIG. 9 is a cross-sectional perspective of the automatic ejector with the controller assembly attached;

FIG. 10 is an electrical schematic showing one possible control operation of the automatic ejector; and

FIG. 11 is a view of the latch and manual release for use with the automatic ejector in place of the automatic pivoter.

For purposes of clarity and brevity, like elements and components will bear the same designations and numbering throughout the FIGURES.

### DETAILED DESCRIPTION

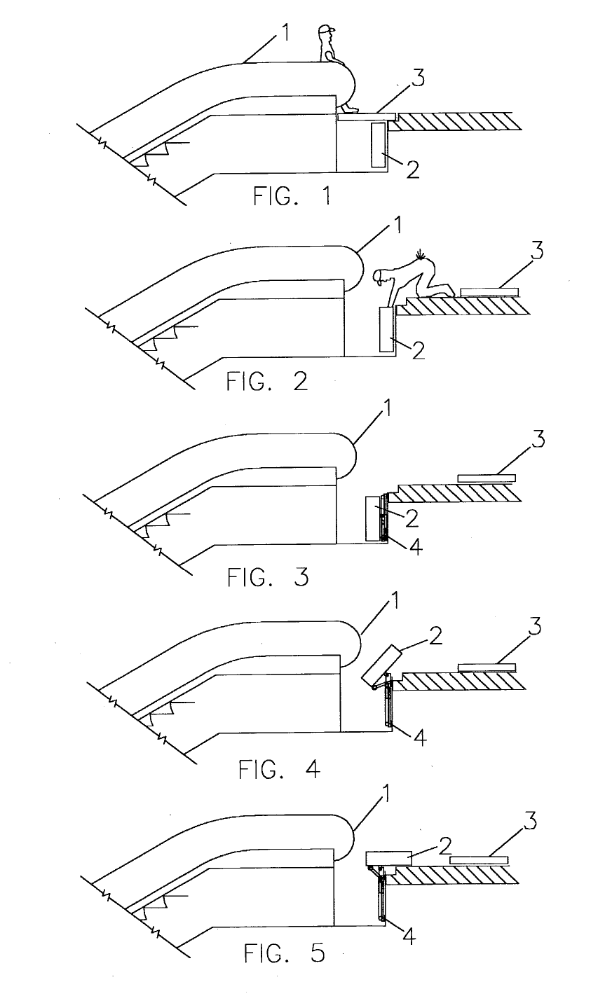

On referring to the drawings in detail, and in particular to FIG. 1, a side view of an upper portion of an escalator 1, which has its controller assembly 2 contained in the upper pit and covered by the escalator floor plate 3.

FIG. 2 is also a side view of an upper portion of an escalator 1 showing the escalator floor plate 3 removed for access to the pit and removal of the controller assembly 2, as it is currently removed by human power.

FIG. 3 is also a side view of an upper portion of an escalator 1 showing the automatic ejector 4 installed against the pit wall, the escalator floor plate 3 removed and the controller assembly 2 retained within the pit.

FIG. 4 is also a side view of an upper portion of an escalator 1 showing the automatic ejector 4 installed against the pit wall, the escalator floor plate 3 removed and the controller assembly 2 partially ejected from the pit by the automatic ejector 4.

FIG. 5 is also a side view of an upper portion of an escalator 1 showing the automatic ejector 4 installed against the pit wall, the escalator floor plate removed 3 and the controller assembly 2 fully ejected from the pit by the automatic ejector 4.

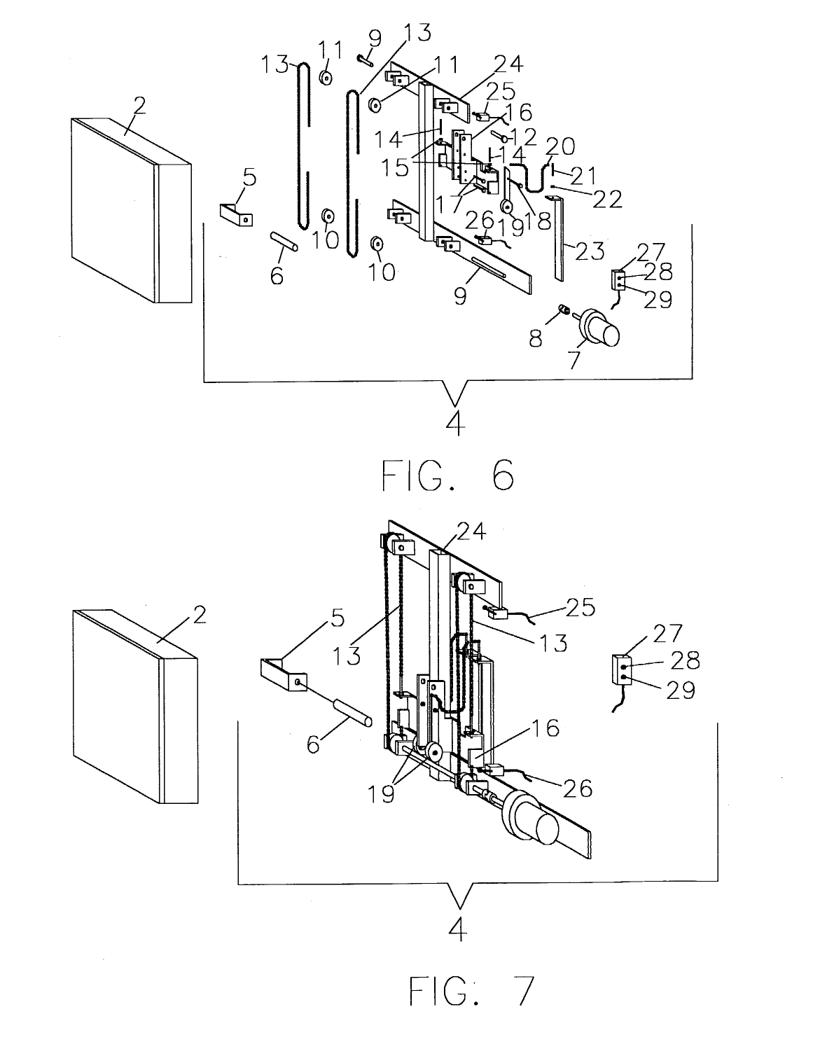

FIG. 6 is an exploded perspective of the controller assembly 2 and the automatic ejector 4 itself, which consists of the controller assembly attachment bracket 5, a device used to attach the controller assembly 2 to the automatic ejector carriage 16 through the insertion of the main attachment pin 6, a shaft that retains the controller assembly 2 to movement in the vertical plane, along with rotational movement about the main attachment pin 6 center of axis. The automatic ejector carriage 16 travels up and down the vertical plane and is guided by the automatic ejector mounting base/guide tube 24, which is rigidly attached to the escalator 1. The automatic ejector carriage 16 is retained to the automatic ejector mounting base/guide tube 24 by insertion of the carriage retainer pin 17 after the automatic ejector carriage 16 is positioned properly around the automatic ejector mounting base/guide tube 24. The carriage retainer pin 17 may be removed and replaced as needed to service portions of the automatic ejector 4. Also attached to the automatic ejector mounting base/guide tube 24 is a return sprocket axle 12, which supports the return sprocket 11, allowing it to rotate. Also supported by the automatic ejector mounting base/guide tube 24, is the drive shaft 9, which is helped to be contained in place by the automatic ejector mounting base/guide tube 24, but is free to rotate to turn the drive sprocket 10. Also attached to the drive shaft 9 is the drive coupling 8, which in turn is connected to the automatic ejector drive motor 7. The automatic ejector drive motor 7 is securely mounted to the automatic ejector mounting base/guide tube 24 and is of adequate size and capacity, that when combined with the drive sprocket 10, results in sufficient power to adequately eject and replace the controller assembly 2.

As seen in FIG. 6, the drive chain 13 is wrapped around the drive sprocket 10 and the return sprocket 11. Each end of the drive chain 13 is secured to the automatic ejector carriage 16, with one end being connected directly to the automatic ejector carriage 16 itself and the other end being secured to the drive chain adjusting rod 14, a threaded rod that is then threaded into the automatic ejector carriage 16 and once adjusted for proper drive chain 13 tension, is secured in place by the drive chain adjusting rod lock nut 15.

As is also seen in FIG. 6, the automatic pivoter bracket 23 is rigidly attached to the automatic ejector mounting base/guide tube 24. Attached to the automatic pivoter bracket 23 is the automatic pivoter chain adjusting rod 21, which is a threaded rod that threads into the automatic pivoter bracket 23. The purpose of the automatic pivoter chain adjusting rod 21 is to adjust the automatic pivoter chain 20 to the proper tension. Once adjusted, the automatic pivoter chain adjusting rod 21 is held in place by the automatic pivoter adjusting rod lock nut 22. The other end of the automatic pivoter chain adjusting rod 21 is connected to the automatic pivoter chain 20, which has its other end connected to the automatic pivoter arm 19. The automatic pivoter arm 19 pivots around the automatic pivoter axle 18, which is securely attached to the automatic ejector carriage 16. By having one end of the automatic pivoter chain 20 stationary by virtue of connection to the automatic pivoter bracket 23 and having the other end travel with the automatic ejector carriage 16, the automatic pivoter chain 20 will become tight prior to the automatic ejector carriage 16 reaching its limit of travel in the up direction, which is the direction of travel to eject the controller assembly 2. Once the automatic pivoter chain 20 becomes tight, the automatic pivoter arm 19 will rotate engaging the controller assembly 2 causing the controller assembly 2 to rotate from its stored vertical position to the ejected horizontal position as it approaches the upper end of travel.

It should be noted as shown in FIG. 11 that an optional latch and manual release 30 can be used in place of the automatic pivoter bracket 23, automatic pivoter chain adjusting rod 21, automatic pivoter adjusting rod lock nut 22, automatic pivoter chain 20, automatic pivoter arm 19 and automatic pivoter axle 18. This latch and manual release 30 is especially useful in configurations where the escalator 1 pit contains too many obstacles, preventing rotation of the controller assembly 2 from vertical to horizontal until it is fully ejected. Use of the latch and manual release 30 allows the controller assembly 2 to be retained and ejected in the vertical position from the escalator 1 pit, and then unlatched and manually pivoted after ejection under the care and control of the technician. Another optional configuration of the automatic ejector 4 is to have the controller assembly 2 rotated 180 degrees from that as shown in FIG. 6 so that the controller assembly 2 door is facing away from the center of the escalator 1 pit instead of towards it. In this orientation the technician can leave the controller assembly 2 in an ejected vertical position and simply open its door to access the contents inside. Modification of the controller assembly attachment bracket 5, main attachment pin 6 and automatic ejector carriage 16 would allow this configuration.

FIG. 7 is a perspective view of the automatic ejector 4 and controller assembly 2 with partial disassembly for clarity. FIG. 7 shows the automatic ejector carriage 16 in the lowered position, with the controller assembly 2 in its stored vertical position. For reference and clarity some of the more recognizable items such as the controller assembly attachment bracket 5, the main attachment pin 6, the automatic pivoter arm 19, the drive chain 13, the automatic ejector mounting base/guide tube 24, the up travel limit switch 25, the automatic ejector carriage 16, the pushbutton station 27, the up pushbutton 28 and the down pushbutton 29 are also noted.

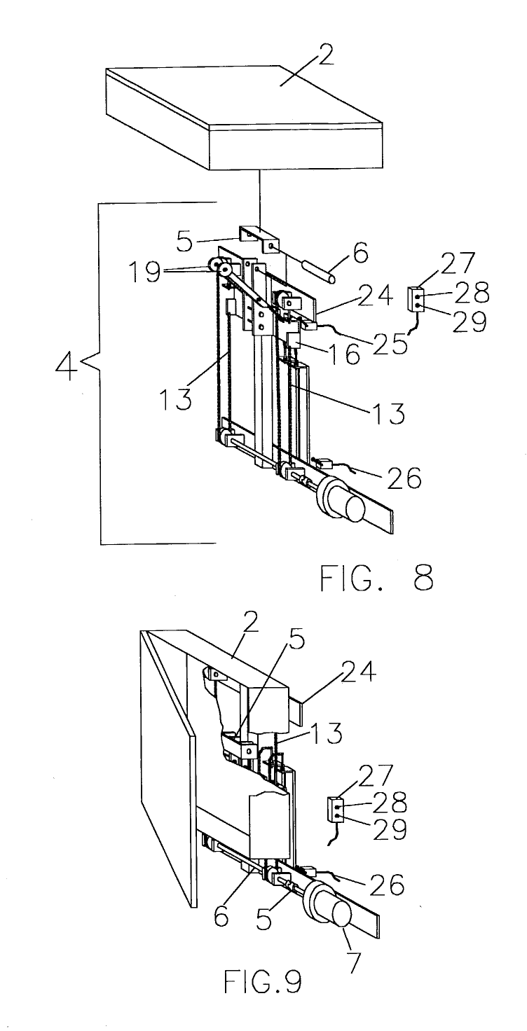

FIG. 8 is a perspective view of the automatic ejector 4 and controller assembly 2 with partial disassembly for clarity. FIG. 8 shows the automatic ejector carriage 16 in the raised position, which is with the controller assembly 2 ejected and rotated to the horizontal position. For reference and clarity some of the more recognizable items such as the controller assembly 2, the controller assembly attachment bracket 5, the main attachment pin 6, the automatic pivoter arm 19, the drive chain 13, the automatic ejector mounting base/guide tube 24, the up travel limit switch 25, the automatic ejector carriage 16, the pushbutton station 27, the up pushbutton 28 and down pushbutton 29 are also noted.

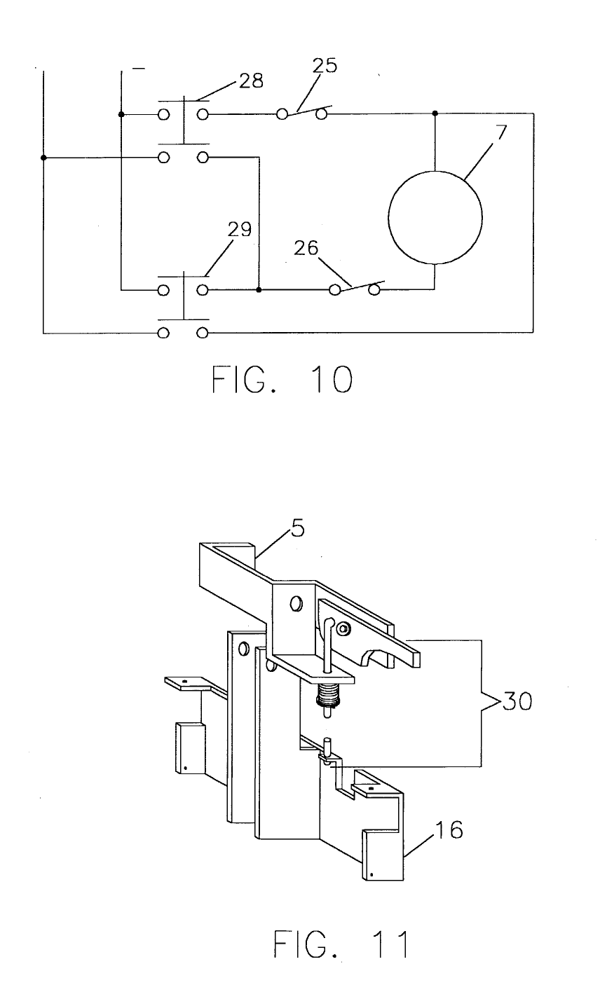

FIG. 9 is a perspective view of the automatic ejector 4 and controller assembly 2 with the controller assembly 2 connected to the automatic ejector 4. For assistance in viewing, the controller assembly 2 is partially cut away. This is in order to show the controller assembly 2 in reference to the automatic ejector 4 when the controller assembly 2 is mounted to the automatic ejector 4 and the controller assembly 2 is retracted and in its stored vertical position. For reference and clarity some of the more recognizable items such as the controller assembly 2, the controller assembly attachment bracket 5, the drive chain 13, the automatic ejector mounting base/guide tube 24, the pushbutton station 27, the up pushbutton 28, the down pushbutton 29, the drive shaft 9, the drive coupling 8, the automatic ejector drive motor 7 and the down travel limit switch 26 are also noted.

FIG. 10 is an electrical ladder schematic showing one possible configuration of how the automatic ejector drive motor 7, the up pushbutton 28, the up travel limit switch 25, the down pushbutton 29 and the down travel limit switch 26 can be wired together to initiate proper operation of the automatic ejector 4.

As seen from the figures the sequence of operation of the automatic ejector 4 is to begin from rest with the controller assembly 2 stored inside the escalator 1 pit in a vertical position and covered by the escalator floor plate 3. After removal of the escalator floor plate 3, the technician then pushes the up pushbutton 28. The up pushbutton 28 and down pushbutton 29 are both mounted securely within the pushbutton station 27, which is securely mounted to the escalator 1 in the pit and in close proximity to the automatic ejector 4. Pushing the up pushbutton 28 sends the up signal to the automatic ejector drive motor 7, which begins its rotation and in turn begins rotating the drive coupling 8 and drive shaft 9. The drive sprocket 10, being securely attached to the drive shaft 9 begins to rotate as well, moving the drive chain 13 causing the automatic ejector carriage 16 to rise and begin ejecting the controller assembly 2. As the automatic ejector carriage 16 approaches the upper limit of travel, the automatic pivoter chain 20 becomes tight causing the automatic pivoter arm 19 to rotate, causing the controller assembly to rotate from its stored vertical position, to its ejected horizontal position. Upon completion of rotation the automatic ejector carriage 16 contacts and trips the up travel limit switch 25 causing the automatic ejector drive motor 7 to shut off and in turn stopping the controller assembly 2 in the ejected, horizontal position. The up travel limit switch 25 is connected to the automatic ejector mounting base/guide tube 24 and is adjustable for differing vertical rises. Retraction and storage of the controller assembly 2 is then accomplished by the technician pushing the down pushbutton 29, which causes the automatic ejector drive motor 7 to receive a down signal and begin rotation of the automatic ejector drive motor 7, the drive coupling 8, the drive shaft 9, and the drive sprocket 10 in the opposite rotation of the ejection process. This in turn causes the drive chain 13 to move causing the automatic ejector carriage 16 to travel down and begin retracting the controller assembly 2 into the pit of the escalator 1. As the automatic ejector carriage 16 travels

Having thus described the invention, what is desired to be protected by Letters Patent is presented in the subsequently appended claims.

What is claimed is:

1. A device for removal of controller assembly from escalator pit to eliminate the risk for human injury comprising:
means for the function of this element is to automatically remove the escalator controller from the escalator pit eliminating the risk of human injury;
means for the function of this element is to provide a means to connect the controller assembly to the automatic ejector carriage.
means for the function of this element is to provide the main interface between the controller assembly and the automatic ejector. this element also provides the main pivot for the controller assembly to pivot around during ejection, rotatably secured to said means for the function of this element is to provide a means to interface the controller assembly to the automatic ejector;
means for the function of this element is to provide the power to drive the automatic ejector;
means for the function of this element is to transmit the power from the drive motor to the drive shaft, securely connected to said means for the function of this element is to provide the power to drive the automatic ejector.
means for the function of this element is to drive the drive sprockets, securely connected to said means for the function of this element is to transmit the power from the drive motor to the drive shaft.
means for the function of this element is to provide for the conversion of rotational power to linear power for the movement of the automatic ejector carriage, securely connected to said means for the function of this element is to drive the drive sprockets;
means for the function of this element is to provide a turn around point for the drive chains;
means for the function of this element is to provide a shaft upon which the return sprockets rotate, rigidly secured to said means for the function of this element is to provide a turn around point for the drive chains;
means for the function of this element is to provide the primary driving means to raise and lower the carriage, rotationally interconnected to said means for the function of this element is to provide a turn around point for the drive chains, and rotatably interconnected to said means for the function of this element is to provide for the conversion of rotational power to linear power for the movement of the automatic ejector carriage;
means for the function of this element is to provide a means to increase or decrease tension on the drive chain, rotatably connected to said means for the function of this element is to provide the primary driving means to raise and lower the carriage;
means for the function of this element is to secure the drive chain adjusting rod in position, threadably inserted to said means for the function of this element is to provide a means to increase or decrease tension on the drive chain;
means for the function of this element is to provide a means of attachment between the drive chains and the controller assembly, frictionally tightened to said means for the function of this element is to secure the drive chain adjusting rod in position, threadably inserted to said means for the function of this element is to provide a means to increase or decrease tension on the drive chain, rotatbly connected to said means for the function of this element is to provide the primary driving means to raise and lower the carriage, and rotatably secured to said means for the function of this element is to provide the main interface between the controller assembly and the automatic ejector. this element also provides the main pivot for the controller assembly to pivot around during ejection;
means for the function of this element is to provide an axle for the automatic pivoter arm to rotate around, rigidly connected to said means for the function of this element is to provide a means of attachment between the drive chains and the controller assembly;
means for the function of this element is to automatically pivot the controller assembly from a vertical orientation to a horizontal one, rotatably connected to said means for the function of this element is to provide an axle for the automatic pivoter arm to rotate around;
means for the function of this element is to rotate the automatic pivoter arm, rotatbly connected to said means for the function of this element is to automatically pivot the controller assembly from a vertical orientation to a horizontal one;
means for the function of this element is to provide a means to increase or decrease tension on the automatic pivoter chain, rotatably connected to said means for the function of this element is to rotate the automatic pivoter arm.
means for the function of this element is to secure the automatic pivoter chain adjusting rod in position, threadably inserted to said means for the function of this element is to provide a means to increase or decrease tension on the automatic pivoter chain;
means for the function of this element is to provide a point of attachment to the mounting base/guide tube for the automatic pivoter adjusting rod, frictionally tightened to said means for the function of this element is to provide a means to increase or decrease tension on the automatic pivoter chain;
means for the function of this element is to provide a main framework and mounting base for the drive motor, the drive shaft, the return sprocket axle, the ejector carriage and retaining pins, the automatic pivoter mounting brackets, the up travel limit switch, the down travel limit switch and the pushbutton station, rigidly attached to said means for the the function of this element is to provide a point of attachment to the mounting base/guide tube for the automatic pivoter adjusting rod, linearly retained to said means for the function of this element is to provide a means of attachment between the drive chains and the controller assembly, rotationally held to said means for the function of this element is to provide a shaft upon which return sprockets rotate, rotationally held to said means for the function of this element is to drive the drive sprockets, and rigidly attached to said means for the function of this element is to provide the power to drive the automatic ejector;
means for the function of this element is to prevent overtravel of the ejector carriage in the up direction, adjustably attached to said means for the function of this element is to provide a main framework and mounting base for the drive motor, the drive shaft, the return sprocket axle, the ejector carriage and retaining pins, the automatic pivoter mounting brackets, the up travel limit switch, the down travel limit switch and the pushbutton station, and electrically connected to said means for the function of this element is to provide power to drive the automatic ejector;
means for the function of this element is to prevent overtravel of the ejector carriage in the down direction, adjustably attached to said means for the function of this element is to provide a main framework and mounting base for the drive motor, the drive shaft, the return sprocket axle, the ejector carriage and retaining pins, the automatic pivoter mounting brackets, the up travel limit switch, the down travel limit switch and the pushbutton station, and electrically connected to said means for the function of this element is to provide power to drive the automatic ejector;
means for the function of this element is to provide a housing for the up and down pushbuttons, rigidly attached to said means for the function of this element is to provide a main framework and mounting base for the drive motor, the drive shaft, the return sprocket axle, the ejector carriage and retaining pins, the automatic pivoter mounting brackets, the up travel limit switch, the down travel limit switch and the pushbutton station;
means for the function of this element is to initiate movement of the ejector carriage in the up direction, rigidly attached to said means for the function of this element is to provide a housing for the up and down pushbuttons, electrically connected to said means for the function of this element is to provide the power to drive the automatic ejector;
means for the function of this element is to initiate movement of the ejector carriage in the down direction, rigidly attached to said means for the function of this element is to provide a housing for the up and down pushbuttons, and electrically connected to said means for the function of this element is to provide the power to drive the automatic ejector; and
means for the function of this element is to provide a means to hold the controller assembly in a vertical position, then allow its release for manual pivoting.

2. The device for removal of controller assembly from escalator pit in accordance with claim 1, wherein said means for the function of this element is to automatically remove the escalator controller from the escalator pit eliminating the risk of human injury comprises an automatic ejector.

3. The device for removal of controller assembly from the escalator pit in accordance with claim 1, wherein said means for the function of this element is to provide a means to connect the controller assembly to the automatic ejector comprises a controller assembly attachment bracket.

4. The device for removal of controller assembly from the escalator pit in accordance with claim 1, wherein said means for the function of this element is to provide the main interface between the controller assembly and automatic ejector. this element also provides the main pivot for the controller assembly to pivot around during ejection comprises a main attachment pin.

5. The device for removal of controller assembly from the escalator pit in accordance with claim 1, wherein said means for the function of these elements is to drive the automatic ejector comprises an automatic ejector drive motor, drive shaft and drive coupling.

6. The device for removal of controller assembly from the escalator pit in accordance with claim 1, wherein said means for the function of this element is to provide for the conversion of rotational power to linear power for movement of the automatic ejector carriage comprises a drive sprocket.

7. The device for removal of controller assembly from the escalator pit in accordance with claim 1, wherein said means for the function of these elements is to provide a turn around point for the drive chain comprises a return sprocket and return sprocket axle.

8. The device for removal of controller assembly from the escalator pit in accordance with claim 1, wherein said means for the function of this element is to provide the primary driving means to raise and lower the carriage comprises a drive chain.

9. The device for removal of controller assembly from the escalator pit in accordance with claim 1, wherein said means for the function of this element is to provide a means to adjust and maintain the drive chain tension comprises a drive chain adjusting rod and drive chain adjusting rod lock nut.

10. The device for removal of controller assembly from the escalator pit in accordance with claim 1, wherein said means for the function of this element is to provide a means of attachment between the drive chains and the controller assembly. comprises an automatic ejector carriage and carriage retainer pin.

11. The device for removal of controller assembly from the escalator pit in accordance with claim 1, wherein said means for the function of these elements is to provide a means to rotate the controller from a vertical position to a horizontal position comprises an automatic pivoter axle, automatic pivoter arm, automatic pivoter chain, automatic pivoter chain adjusting rod, automatic pivoter chain adjusting rod lock nut and automatic pivoter bracket.

12. The device for removal of controller assembly from the escalator pit in accordance with claim 1, wherein said means for the function of this element is to provide a main framework and mounting base for the drive motor, the drive shaft, the return sprocket axle, the ejector carriage and retaining pins, the automatic pivoter mounting bracket, the up travel limit switch, the down travel limit switch and the pushbutton station. comprises an automatic ejector mounting base/guide tube.

13. The device for removal of controller assembly from the escalator pit in accordance with claim 1, wherein said means for the function of these elements is to prevent over travel of the ejector carriage in the up and down directions of travel. comprises an up travel limit switch and a down travel limit switch.

14. The device for removal of controller assembly from the escalator pit in accordance with claim 1, wherein said means for the function of this element is to provide a housing for the up and down pushbuttons. comprises a pushbutton station.

15. The device for removal of controller assembly from the escalator pit in accordance with claim 1, wherein said means for the function of this element is to initiate movement of the ejector carriage in the up or down direction. comprises an up and down pushbutton.

16. The device for removal of controller assembly from the escalator pit in accordance with claim 1, wherein said means for the function of this element is to provide a means to hold the controller assembly in a vertical position, then to allow its release for manual pivoting. comprises a latch and manual release.

17. A device for removal of controller assembly from the escalator pit to eliminate the chance for human injury comprising:
an escalator, for the function of this element is for providing clarification as to what the upper portion of an escalator looks like and to locate the escalator controller;
a controller assembly, for the function of this element is to identify the item to be removed by the automatic ejector;
an escalator floor plate, for the function of this element is to provide concealment of the escalator pit, removably fitted to said Escalator;
an automatic ejector, for the function of this element is to automatically remove the escalator controller assembly from the escalator pit eliminating the risk of human injury, rigidly attached to said Escalator;
a controller assembly attachment bracket, for the function of this element is to provide a means to connect the controller assembly to the automatic ejector, rigidly attached to said Controller Assembly;
a main attachment pin, for the function of this element is to provide the main interface between the controller assembly and the automatic ejector. this element also provides the main pivot for the controller assembly to pivot around during ejection, rotatably secured to said Controller Assembly Attachment Bracket;
an automatic ejector drive motor, for the function of this element is to provide the power to drive the automatic ejector;
a drive coupling, for the function of this element is to transmit the power from the drive motor to the drive shaft, securely connected to said Automatic Ejector Drive Motor;
a drive shaft, for the function of this element is to drive the drive sprocket, securely connected to said Drive Coupling;
a drive sprocket, for the function of this element is to provide for the conversion of rotational power to linear power for movement of the automatic ejector carriage, securely connected to said Drive Shaft;
a return sprocket, for the function of this element is to provide a turn around point for the drive chain;
a return sprocket axle, for the function of this element is to provide a shaft upon which the return sprocket rotates, rigidly secured to said Return Sprocket;
a drive chain, for the function of this element is to provide the primary means to raise and lower the ejector carriage, rotationally interconnected to said Return Sprocket, and rotationally interconnected to said Drive Sprocket;
a drive chain adjusting rod, for the function of this element is to provide a means to increase or decrease tension on the drive chain, rotatably connected to said Drive Chain;
a drive chain adjusting rod lock nut, for the function of this element is to secure the drive chain adjusting rod in position, threadably connected to said Drive Chain Adjusting Rod;
an automatic ejector carriage, for the function of this element is to provide a means of attachment between the drive chain and controller assembly, frictionally tightened to said Drive Chain Adjusting Rod Lock Nut, threadably inserted to said Drive Chain Adjusting Rod, rotatably connected to said Drive Chain and rotatably secured to said Main Attachment Pin;
a carriage retainer pin, for the function of this element is to contain the automatic ejector carriage on its guide tube;
an automatic pivoter axle, for the function of this element is to provide an axle for the automatic pivoter arm to rotate around, rigidly attached to said Automatic Ejector Carriage;
an automatic pivoter arm, for the function of this element is to automatically pivot the controller assembly from a vertical position to a horizontal one, rotatably connected to said Automatic Pivoter Axle;
an automatic pivoter chain, for the function of this element is to rotate the automatic pivoter arm, rotatably connected to said Automatic Pivoter Arm;
an automatic pivoter chain adjusting rod, for the function of this element is to provide a menas to increase or decrease tension on the automatic pivoter chain, rotatably connected to said Automatic Pivoter Chain;
an automatic pivoter adjusting rod lock nut, for the function of this element is to secure the automatic pivoter chain adjusting rod in position, threadably connected to said Automatic Pivoter Chain Adjusting Rod;
an automatic pivoter bracket, for the function of this element is to provide a point of attachment for the automatic pivoter adjusting rod, frictionally tightened to said Automatic Pivoter Adjusting Rod Lock Nut, and threadably attached to said Automatic Pivoter Chain Adjusting Rod;
an automatic ejector mounting base/guide tube, for the function of this element is to provide a main framework and mounting base for the drive motor, the drive shaft, the return sprocket axle, the ejector carriage and retainer pin, the automatic pivoter mounting bracket, the up travel limit switch, the down travel limit switch and the pushbutton station, rigidly attached to said Automatic Pivoter Bracket, linearly retained to said Automatic Ejector Carriage, rotationally held to said Drive Shaft, rotationally held to said Return Sprocket Axle, rigidly attached to said Automatic Ejector Drive Motor, and rigidly attached to said Escalator;
an up travel limit switch, for the function of this element is to prevent over travel of the ejector carriage in the up direction, adjustably attached to said Automatic Ejector Mounting Base/Guide Tube, and electrically connected to said Automatic Ejector Drive Motor;
a down travel limit switch, for the function of this element is to prevent over travel of the ejector carriage in the down direction, adjustably attached to said Automatic Ejector Mounting Base/Guide Tube, and electrically connected to said Automatic Ejector Drive Motor.
a pushbutton station, for the function of this element is to provide a housing for the up and down pushbuttons, rigidly attached to said Automatic Ejector Mounting Base/Guide Tube;
an up pushbutton, for the function of this element is to initiate movement of the ejector carriage in the up direction, rigidly attached to said Pushbutton Station, and electrically connected to said Automatic Ejector Drive Motor;
a down pushbutton, for the function of this element is to initiate movement of the ejector carriage in the down direction, rigidly attached to said Pushbutton Station, and electrically connected to said Automatic Ejector Drive Motor; and
a latch and manual release, for the function of this element is to provide a means to hold the controller assembly in a vertical position, then to allow its release for manual pivoting.
